(19) United States
(12) Patent Application Publication
(10) Pub. No.: US 2026/0086232 A1
(43) Pub. Date: Mar. 26, 2026

(54) WEARABLE DEVICE PROXIMITY DETECTION USING INFRARED LIGHT

(71) Applicant: Meta Platforms Technologies, LLC, Menlo Park, CA (US)

(72) Inventors: Xiyu Duan, Sammamish, WA (US); Travis Taylor, San Jose, CA (US); Inigo Arnaiz Duenas, Snohomish, WA (US); Chung-Che Huang, Cupertino, CA (US)

(21) Appl. No.: 19/339,261

(22) Filed: Sep. 24, 2025

Related U.S. Application Data
(60) Provisional application No. 63/698,173, filed on Sep. 24, 2024.

(51) Int. Cl. G01S 17/04; G01S 7/481; G06F 3/01

(52) U.S. Cl. CPC G01S 17/04; G01S 7/4815; G06F 3/012

(57) ABSTRACT

A wearable device including wear detecting is described. The device includes, a frame configured to be worn on a face of a wearer, a skin sensor disposed in a portion of the frame, the skin sensor comprising at least one light emitter configured to emit light in a short-wave infrared (SWIR) wavelength range and at least one light detector configured to capture reflected light, and one or more processors. The one or more processors are configured to cause the at least one light emitter to emit the light in the SWIR wavelength range, obtain signals characteristic of reflected light captured by the at least one light detector, and determine whether a user is wearing the wearable device on the face of the wearer based at least in part on the obtained signals.

### RELATED APPLICATION

This application claims priority to U.S. Provisional Application Serial No. 63/698,173, filed September 24, 2024, entitled “Wearable Device Wear Detection,” which is incorporated herein by reference.

### TECHNICAL FIELD

This relates generally to detecting the proximity of a wearable device to a user via infrared light.

### BACKGROUND

Users are increasingly wearing smart glasses, augmented reality (AR) and/or virtual reality (VR) headsets, or other types of wearable devices. It is critical to accurately detect when a user is wearing such a device, e.g., in order to accurately power on the device, present content when the device is being worn, etc. However, such wear detection is difficult to perform accurately. For example, a device may incorrectly be detected as being worn when in a backpack, when being worn on the top of the user’s head rather than on their face, etc., which may lead to poor battery life. Conversely, a device may incorrectly be detected as not being worn, which may diminish a user experience by not initiating various device actions when being worn.

As such, there is a need to address one or more of the above-identified challenges. A brief summary of solutions to the issues noted above is described below.

### SUMMARY

In one example scenario, a user is jogging through the park while listening to a podcast on his smart glasses. As he approaches a café, he decides to take a break. He removes the glasses and places them on the table. The sensor on the bridge of the glasses detects the change in reflectivity, recognizing that the user is no longer wearing them.

Upon detection, the smart glasses automatically switch to low power mode to conserve battery. Additionally, the podcast can seamlessly transfer to 'the user’s smartwatch, allowing him to continue listening without interruption. This feature ensures that the user can enjoy his break without worrying about battery life or missing any part of the podcast.

One example of a wearable device including a wear-detection feature is described. The device includes a frame configured to be worn on the face of a wearer, a wear detection sensor disposed in a portion of the frame, the wear detection sensor comprising at least one light emitter configured to emit light in a short-wave infrared (SWIR) wavelength range and at least one light detector configured to capture reflected light, and one or more processors. The one or more processors are configured to cause the at least one light emitter to emit the light in the SWIR wavelength range, obtain signals characteristic of reflected light captured by the at least one light detector, and determine whether a user is wearing the wearable device on the face of the wearer based at least in part on the obtained signals.

Instructions that cause performance of the methods and operations described herein can be stored on a non-transitory computer-readable storage medium. The non-transitory computer-readable storage medium can be included on a single electronic device or spread across multiple electronic devices of a system (computing system). A non-exhaustive list of electronic devices that can either alone or in combination (e.g., a system) perform the method and operations described herein includes an extended-reality (XR) headset/glasses (e.g., a mixed-reality (MR) headset or a pair of augmented-reality (AR) glasses as two examples), a wrist-wearable device, an intermediary processing device, a smart textile-based garment, etc. For instance, the instructions can be stored on a pair of AR glasses or can be stored on a combination of a pair of AR glasses and an associated input device (e.g., a wrist-wearable device) such that instructions for causing detection of input operations can be performed at the input device and instructions for causing changes to a displayed user interface in response to those input operations can be performed at the pair of AR glasses. The devices and systems described herein can be configured to be used in conjunction with methods and operations for providing an XR experience. The methods and operations for providing an XR experience can be stored on a non-transitory computer-readable storage medium.

The devices and/or systems described herein can be configured to include instructions that cause the performance of methods and operations associated with the presentation and/or interaction with an extended-reality (XR) headset. These methods and operations can be stored on a non-transitory computer-readable storage medium of a device or a system. It is also noted that the devices and systems described herein can be part of a larger, overarching system that includes multiple devices. A non-exhaustive list of electronic devices that can, either alone or in combination (e.g., a system), include instructions that cause the performance of methods and operations associated with the presentation and/or interaction with an XR experience includes an extended-reality headset (e.g., a mixed-reality (MR) headset or a pair of augmented-reality (AR) glasses as two examples), a wrist-wearable device, an intermediary processing device, a smart textile-based garment, etc. For example, when an XR headset is described, it is understood that the XR headset can be in communication with one or more other devices (e.g., a wrist-wearable device, a server, an intermediary processing device), which together can include instructions for performing methods and operations associated with the presentation and/or interaction with an extended-reality system (i.e., the XR headset would be part of a system that includes one or more additional devices). Multiple combinations with different related devices are envisioned but not recited for brevity.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIGS. 1A-1C illustrate an example of wear detection, in accordance with some embodiments.

FIGS. 2A-2C illustrate an example of sensor signal data obtained from an example of a wear detection sensor, in accordance with some embodiments.

FIG. 3 illustrates example components for a wear detection sensor and -wear detection sensor housing, in accordance with some embodiments.

FIGS. 4A-4C illustrate an example implementation of a wear detection sensor to reduce cross-talk, in accordance with some embodiments.

FIG. 5 illustrates a flowchart of an example process for wear detection, in accordance with some embodiments.

FIGS. 6A, 6B, 6C-1, and 6C-2 illustrate examples of MR and AR systems, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

### Overview

Embodiments of this disclosure can include or be implemented in conjunction with various types of extended-realities (XRs) such as mixed-reality (MR) and augmented-reality (AR) systems. MRs and ARs, as described herein, are any superimposed functionality and/or sensory-detectable presentation provided by MR and AR systems within a user’s physical surroundings. Such MRs can include and/or represent virtual realities (VRs) and VRs in which at least some aspects of the surrounding environment are reconstructed within the virtual environment (e.g., displaying virtual reconstructions of physical objects in a physical environment to avoid the user colliding with the physical objects in a surrounding physical environment). In the case of MRs, the surrounding environment that is presented through a display is captured via one or more sensors configured to capture the surrounding environment (e.g., a camera sensor, time-of-flight (ToF) sensor). While a wearer of an MR headset can see the surrounding environment in full detail, they are seeing a reconstruction of the environment reproduced using data from the one or more sensors (i.e., the physical objects are not directly viewed by the user). An MR headset can also forgo displaying reconstructions of objects in the physical environment, thereby providing a user with an entirely VR experience. An AR system, on the other hand, provides an experience in which information is provided, e.g., through the use of a waveguide, in conjunction with the direct viewing of at least some of the surrounding environment through a transparent or semi-transparent waveguide(s) and/or lens(es) of the AR glasses. Throughout this application, the term “extended reality (XR)” is used as a catchall term to cover both ARs and MRs. In addition, this application also uses, at times, a head-wearable device or headset device as a catchall term that covers XR headsets such as AR glasses and MR headsets.

As alluded to above, an MR environment, as described herein, can include, but is not limited to, non-immersive, semi-immersive, and fully immersive VR environments. As also alluded to above, AR environments can include marker-based AR environments, markerless AR environments, location-based AR environments, and projection-based AR environments. The above descriptions are not exhaustive and any other environment that allows for intentional environmental lighting to pass through to the user would fall within the scope of an AR, and any other environment that does not allow for intentional environmental lighting to pass through to the user would fall within the scope of an MR.

The AR and MR content can include video, audio, haptic events, sensory events, or some combination thereof, any of which can be presented in a single channel or in multiple channels (such as stereo video that produces a three-dimensional effect to a viewer). Additionally, AR and MR can also be associated with applications, products, accessories, services, or some combination thereof, which are used, for example, to create content in an AR or MR environment and/or are otherwise used in (e.g., to perform activities in) AR and MR environments.

Interacting with these AR and MR environments described herein can occur using multiple different modalities and the resulting outputs can also occur across multiple different modalities. In one example AR or MR system, a user can perform a swiping in-air hand gesture to cause a song to be skipped by a song-providing application programming interface (API) providing playback at, for example, a home speaker.

A hand gesture, as described herein, can include an in-air gesture, a surface-contact gesture, and or other gestures that can be detected and determined based on movements of a single hand (e.g., a one-handed gesture performed with a user’s hand that is detected by one or more sensors of a wearable device (e.g., electromyography (EMG) and/or inertial measurement units (IMUs) of a wrist-wearable device, and/or one or more sensors included in a smart textile wearable device) and/or detected via image data captured by an imaging device of a wearable device (e.g., a camera of a head-wearable device, an external tracking camera setup in the surrounding environment)). “In-air” generally includes gestures in which the user’s hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single- or double-finger tap on a table, on a user’s hand or another finger, on the user’s leg, a couch, a steering wheel). The different hand gestures disclosed herein can be detected using image data and/or sensor data (e.g., neuromuscular signals sensed by one or more biopotential sensors (e.g., EMG sensors) or other types of data from other sensors, such as proximity sensors, ToF sensors, sensors of an IMU, capacitive sensors, strain sensors) detected by a wearable device worn by the user and/or other electronic devices in the user’s possession (e.g., smartphones, laptops, imaging devices, intermediary devices, and/or other devices described herein).

The input modalities as alluded to above can be varied and are dependent on a user’s experience. For example, in an interaction in which a wrist-wearable device is used, a user can provide inputs using in-air or surface-contact gestures that are detected using neuromuscular signal sensors of the wrist-wearable device. In the event that a wrist-wearable device is not used, alternative and entirely interchangeable input modalities can be used instead, such as camera(s) located on the headset/glasses or elsewhere to detect in-air or surface-contact gestures or inputs at an intermediary processing device (e.g., through physical input components (e.g., buttons and trackpads)). These different input modalities can be interchanged based on both desired user experiences, portability, and/or a feature set of the product (e.g., a low-cost product may not include hand-tracking cameras).

While the inputs are varied, the resulting outputs stemming from the inputs are also varied. For example, an in-air gesture input detected by a camera of a head-wearable device can cause an output to occur at a head-wearable device or control another electronic device different from the head-wearable device. In another example, an input detected using data from a neuromuscular signal sensor can also cause an output to occur at a head-wearable device or control another electronic device different from the head-wearable device. While only a couple examples are described above, one skilled in the art would understand that different input modalities are interchangeable along with different output modalities in response to the inputs.

Specific operations described above may occur as a result of specific hardware. The devices described are not limiting and features on these devices can be removed or additional features can be added to these devices. The different devices can include one or more analogous hardware components. For brevity, analogous devices and components are described herein. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device, a head-wearable device, a handheld intermediary processing device (HIPD), a smart textile-based garment, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., VR animations, such as three-dimensional modeling); (iv) a field-programmable gate array (FPGA) that can be programmed and reconfigured after manufacturing and/or customized to perform specific tasks, such as signal processing, cryptography, and machine learning; or (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs. As described herein, a graphics module is a component or software module that is designed to handle graphical operations and/or processes and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or (v) any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) pogo pins, which may be small, spring-loaded pins configured to provide a charging interface; (v) wireless charging interfaces; (vi) global-positioning system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device, such as a simultaneous localization and mapping (SLAM) camera); (ii) biopotential-signal sensors (used interchangeably with neuromuscular-signal sensors); (iii) IMUs for detecting, for example, angular rate, force, magnetic field, and/or changes in acceleration; (iv) heart rate sensors for measuring a user’s heart rate; (v) peripheral oxygen saturation (SpO₂) sensors for measuring blood oxygen saturation and/or other biometric data of a user; (vi) capacitive sensors for detecting changes in potential at a portion of a user’s body (e.g., a sensor-skin interface) and/or the proximity of other devices or objects; (vii) sensors for detecting some inputs (e.g., capacitive and force sensors); and (viii) light sensors (e.g., ToF sensors, infrared light sensors, or visible light sensors), and/or sensors for sensing data from the user or the user’s environment. As described herein biopotential-signal-sensing components are devices used to measure electrical activity within the body (e.g., biopotential-signal sensors). Some types of biopotential-signal sensors include (i) electroencephalography (EEG) sensors configured to measure electrical activity in the brain to diagnose neurological disorders; (ii) electrocardiography (ECG or EKG) sensors configured to measure electrical activity of the heart to diagnose heart problems; (iii) EMG sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications; (x) camera applications; (xi) web-based applications; (xii) health applications; (xiii) AR and MR applications; and/or (xiv) any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). A communication interface can refer to a software layer that enables different software programs to communicate with each other (e.g., APIs and protocols such as HTTP and TCP/IP).

As described herein, a graphics module is a component or software module that is designed to handle graphical operations and/or processes and can include a hardware module and/or a software module.

As described herein, non-transitory computer-readable storage media are physical devices or storage medium that can be used to store electronic data in a non-transitory form (e.g., such that the data is stored permanently until it is intentionally deleted and/or modified).

### Wearable Device Detection

Users are increasingly wearing smart glasses, augmented reality (AR) and/or virtual reality (VR) headsets, or other types of wearable devices. It is critical to accurately detect when a user is wearing such a device, e.g., in order to accurately power on the device, present content when the device is being worn, etc. However, such wear detection is difficult to perform accurately. For example, a device may incorrectly be detected as being worn when in a backpack, when being worn on the top of the user’s head rather than on their face, etc., which may lead to poor battery life. Conversely, a device may incorrectly be detected as not being worn, which may diminish the user experience by not initiating various device actions when being worn.

Certain techniques may utilize a capacitive sensor for wear detection. For example, changes in capacitance may be used to detect whether or not a user is wearing a pair of smart glasses or an AR/VR headset. However, certain capacitive sensors may not accurately detect whether or not a device is being worn. For example, devices that utilize certain capacitive sensors may yield inaccurate results if the device slips against the user’s skin (e.g., while walking or moving), if wet hair touches the sensor, if the device is placed in a backpack or on top of the user’s head, etc. The device inaccurately determining that it is being worn may cause the battery to run down.

Disclosed herein are techniques for wear detection of wearable devices. In general, the techniques disclosed herein are described with respect to head-worn devices, such as smart glasses and/or AR/VR headsets; however, the techniques may be implemented with other wearable devices, such as a smartwatch, a smart ring, a smart bracelet, etc. The techniques disclosed herein utilize an infrared sensor. In particular, light in the short-wave infrared (SWIR) region may be transmitted, and the reflected signal (e.g., reflected off skin of the wearer, reflected off any other object in proximity, such as hair, a backpack, etc.) may be characterized to determine if the wearer is wearing the device. In some embodiments, the transmitted light may be within the range of 1000 nm and 1800 nm, between 900 nm and 1500 nm, or the like. In some implementations, light may be transmitted at two wavelengths, and the ratio of the reflected signal associated with the two wavelengths may be used to detect that the sensor is proximate to the user’s skin, and therefore, that the user is wearing the device (e.g., on their face). In some embodiments, the ratio may be compared to a predetermined threshold to detect whether the user is wearing the device. A wear detection sensor used to detect whether the wearable device is being worn is sometimes referred to herein as a “skin sensor,” because the sensor data may be analyzed to detect whether the sensor is proximate to the skin of the wearer.

Human skin has a unique reflectance spectrum that is different from other objects due to its scattering and absorption properties. The reflectance spectra are heavily dependent on skin tone; however, there is much less variability in the SWIR range as absorption is mainly dominated by water. A wear detection sensor may be placed at any suitable position on a head-worn wearable device. For example, with regard to a pair of smart glasses, a wear detection sensor may be placed on an inner portion of an arm of the smart glasses, on a portion of the smart glasses configured to contact a forehead of the wearer, on a portion of the smart glasses configured to contact the nose of the wearer, or the like. As another example, with regard to an AR/VR headset, a wear detection sensor may be placed on an inner portion of the headset configured to contact the forehead of the wearer, an inner portion of the headset configured to contact the cheek of the wearer, etc.

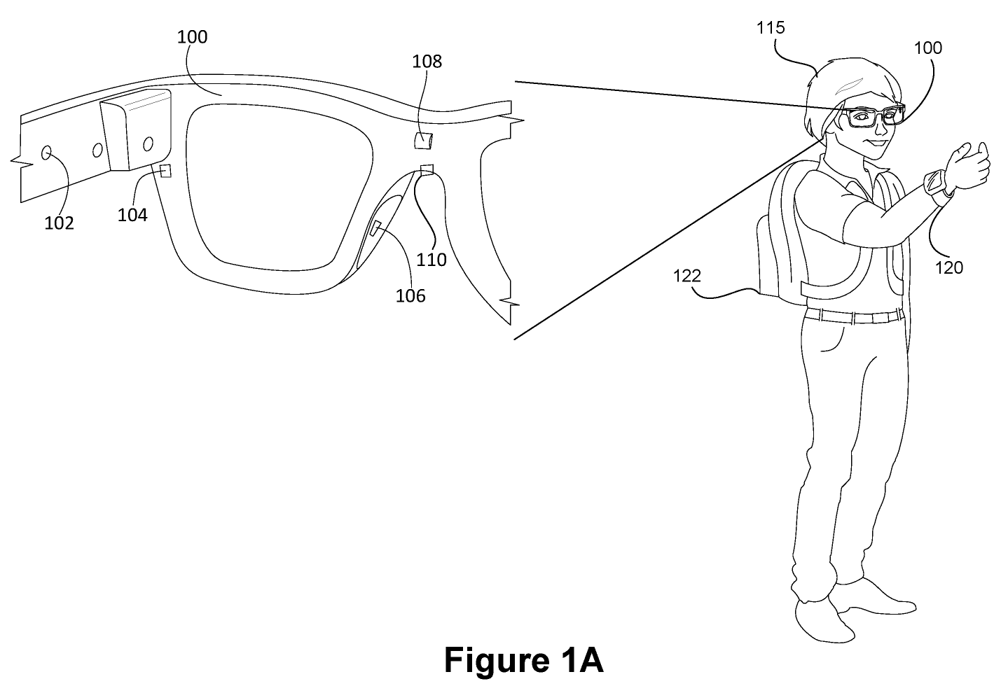

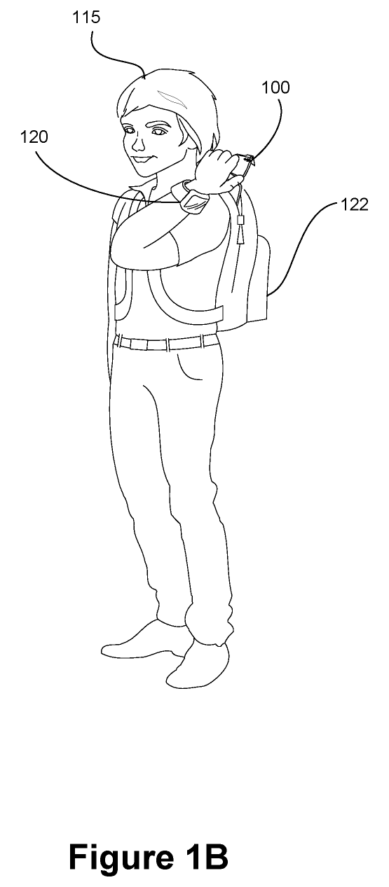

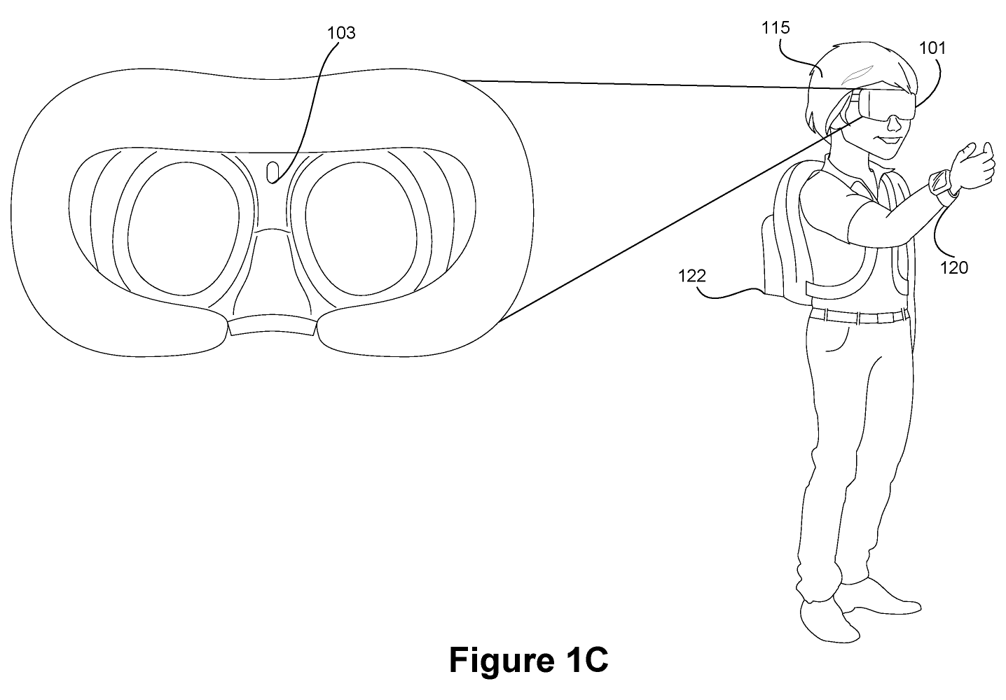

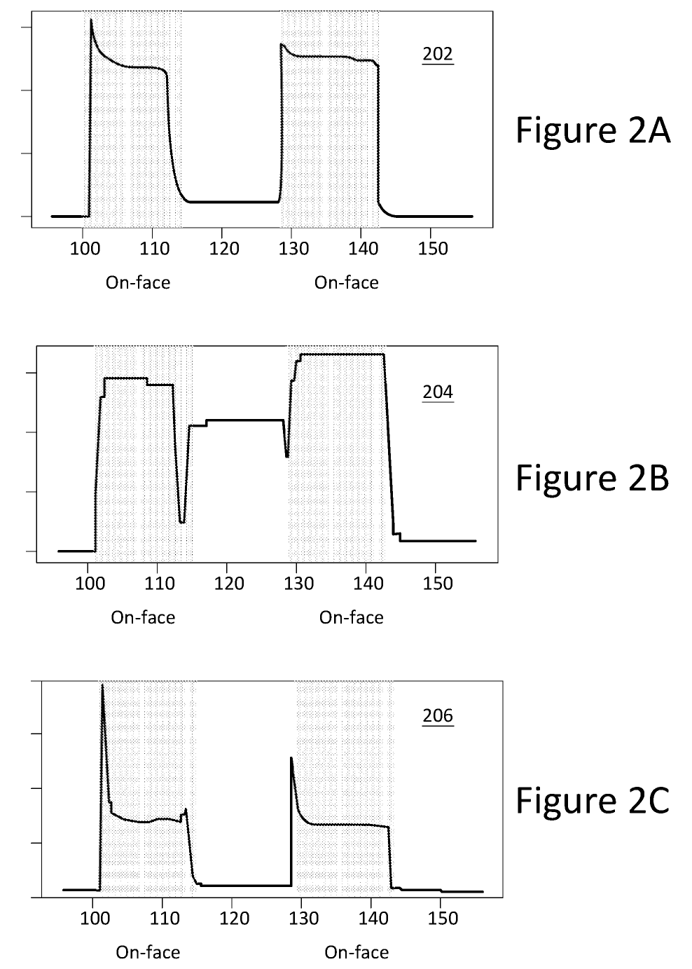

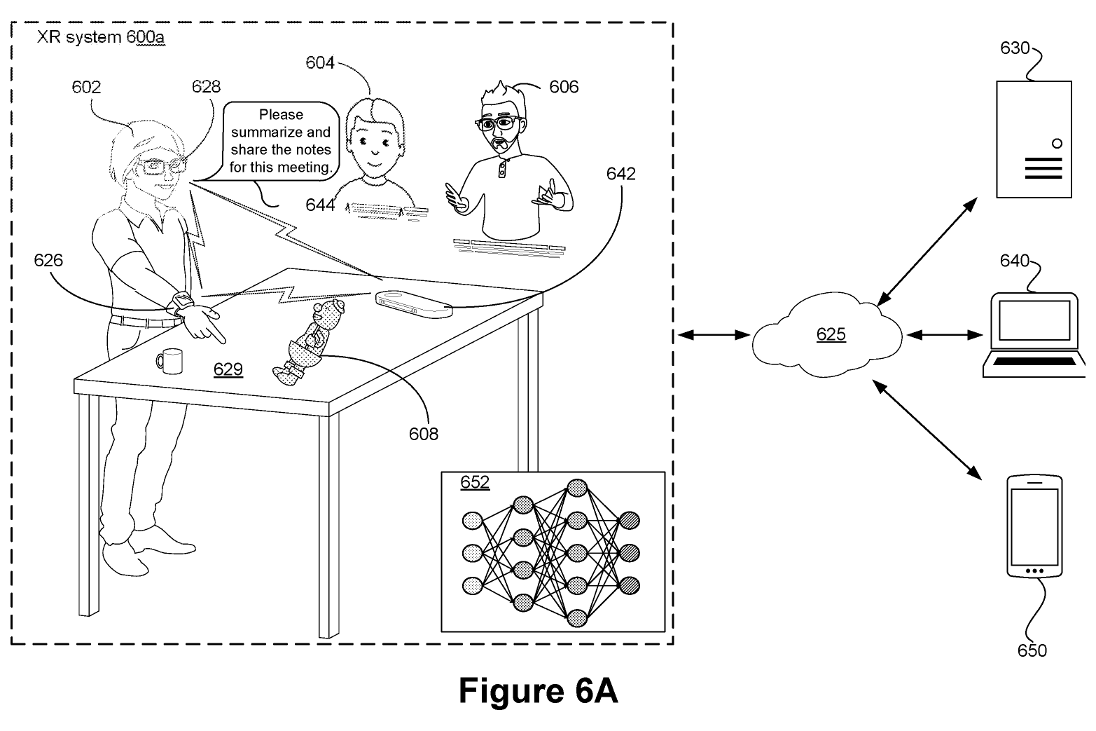

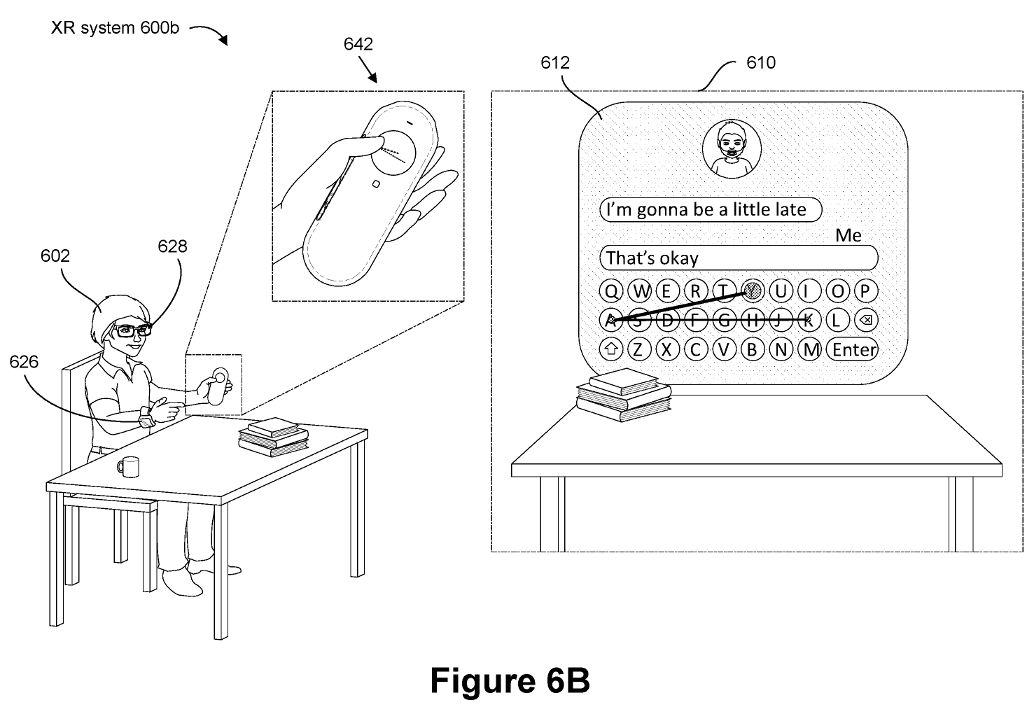

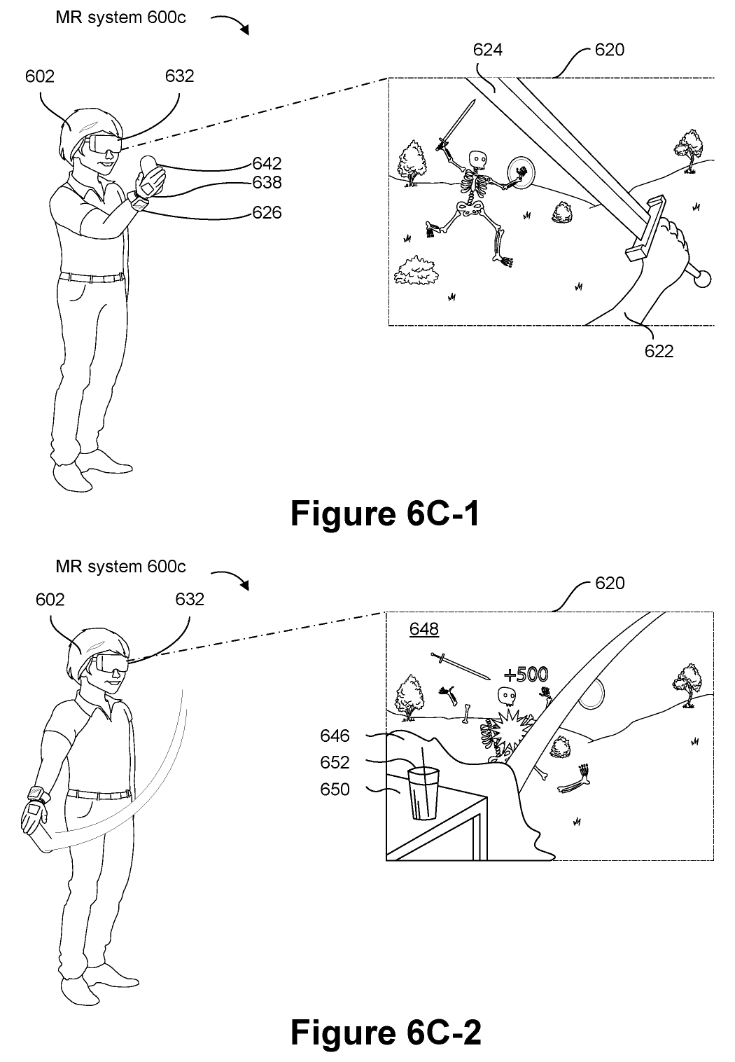

FIGS. 1A-1C illustrate an example of wear detection, in accordance with some embodiments. For example, FIG. 1A illustrates a user 115 (e.g., a wearer) wearing a head-wearable device 100. FIG. 1A further illustrates the user 115 wearing a wrist-wearable device 120 communicatively coupled with the head-wearable device 100 and a backpack 122. In some embodiments, the head-wearable device 100 may be a pair of smart glasses (e.g., as shown in FIGS. 1A-1B) or an AR/VR headset (e.g., as shown in FIG. 1C). In some embodiments, the head-wearable device 100 is communicatively coupled to an intermediary processing device and/or a smartphone as described in FIGS. 6A-6C-2.

FIG. 1A further illustrates various possible locations for a wear detection sensor on a head-wearable device 100. For example, a wear detection sensor 102 may be placed on an inner portion of an arm of the glasses. As another example, a wear detection sensor 104 may be placed on an inner portion of a rim associated with a lens of the smart glasses configured to face skin near an eye of the wearer. As yet another example, a wear detection sensor 106 may be placed on an inner portion of a rim configured to be in proximity to or be in contact with the wearer’s nose. As still another example, a wear detection sensor 108 may be placed on an inner portion of a bridge of the glasses be in proximity to or be in contact with the portion of the user 115’s nose. Note that although four exemplary wear detection sensors are illustrated, a device may include one wear detection sensor, or multiple wear detection sensors. FIG. 1A further illustrates wear detection sensor 110 which is disposed on the underside of the bridge of the nose of the user 115 such that while the user 115 is wearing the head-wearable device, the wear detection sensor 110 can be in proximity to or be in contact with the top of the bridge of the user 115’s nose.

The one or more wear detection sensors of the head-wearable device 100 detect whether or not the user is wearing the head-wearable device 100 on their face. In some embodiments, the wear detection sensors determine (1) how far away an object (e.g., the user’s face or another object such as a sweater) is and (2) what type of object is within proximity to the head-wearable device 100 (e.g., such as the user’s face or another object). For example, as shown in FIG. 1A, the wear detection sensor determines that the head-wearable device 100 is a threshold distance (e.g., 1-15mm) away from an object (e.g., the user’s face). The wear detection sensor further determines that the object in proximity to the head-wearable device 100 is the user’s face.

FIG. 1B illustrates the user 115 removing the head-wearable device 100 from their face and placing it in a backpack 122, in some embodiments. The one or more wear detection sensors of the head-wearable device 100 detect that the user 115 is no longer wearing the head-wearable device 100 on their face. For example, when the user 115 places the head-wearable device 100 into the backpack 122, the proximity of the wear detection sensor disposed in the head-wearable device 100 is no longer within a threshold distance of an object (e.g., the user 115’s face or something else). In another example, the proximity of the wear detection sensor is within a threshold distance of another object, but not within proximity to the user 115’s face.

In some embodiments, detection that the user 115 is no longer wearing the head-wearable device 100 may cause a change in the interaction between the user 115 and the head-wearable device 100. For example, the user 115 is viewing a user interface (UI) displayed at the head-wearable device 100, and when the head-wearable device 100 determines that the user 115 is no longer wearing the head-wearable device 100, the head-wearable device 100 ceases to display the UI at the head-wearable device 100. In a further example, the UI may transfer to a display at the wrist-wearable device 120 or any other communicatively coupled device with a display. In some embodiments, while the user 115 is wearing the head-wearable device 100, the head-wearable device 100 can generate audio (e.g., a podcast, music, etc.), and when the head-wearable device 100 determines that the user 115 is no longer wearing the head-wearable device 100, the head-wearable device 100’s audio output pauses. In a further example, the audio output may transfer to and continue playing at the wrist-wearable device 120 or another communicatively coupled device with an audio output. In some embodiments, when the head-wearable device 100 determines that the user 115 is no longer wearing the head-wearable device 100, notifications that would have previously been displayed to the user 115 via the head-wearable device 100 as at least one of audio, visual, or haptic output, may now be displayed at the wrist-wearable device 120, or any other communicatively coupled device.

In some embodiments, detection that the user 115 is no longer wearing the head-wearable device 100 may result in an alteration in the functions of the head-wearable device 100. For example, when the head-wearable device 100 determines that the user 115 is no longer wearing the head-wearable device 100, certain sensors, processors, and optionally the entire device may stop collecting or processing data and therefore no longer consume power. As a further example, a determination that the user 115 is no longer wearing the head-wearable device 100 may result in visual, audio, or haptic sensors being deactivated in order to save power while the head-wearable device 100 is no longer in use by the user 115. In some embodiments, in accordance with a determination, the head-wearable device 100 is no longer worn by the user 115, deactivating all sensors with exception to the wear detection sensor. In a further example, the wear detection sensor is deactivated as well in accordance with a determination that the head-wearable device 100 is being charged.

FIG. 1C illustrates a user 115 wearing an AR/VR headset, in accordance with some embodiments. In some embodiments, the AR/VR headset is a second head-wearable device 101 that includes a wear detection sensor 103, which includes all of the properties of the wear detection sensors discussed above and below. Additionally, the second head-wearable device 101 includes other locations for the wear detection sensor including locations analogous to those illustrated and discussed in FIG. 1A.

FIGS. 2A-2C illustrate plots of wear detection sensor data from an example wear detection sensor in accordance with some embodiments. For the example data illustrated in FIGS. 2A-2C, two light sources were utilized, with both light sources transmitting light in the SWIR region. Plot 202 illustrates reflectance data plotted against time associated with a first light transmitter at a first wavelength as obtained by a light detector, plot 204 illustrates reflectance data plotted against time associated with a second light transmitted at a second wavelength as obtained by the light detector, and plot 206 illustrates the ratio of reflectance data of the first and second light transmitter plotted against time as obtained by the light detector. Note that regions corresponding to time during which the smart glasses were worn on the face are highlighted along the x-axis. Time along the x-axis not marked as “on-face” corresponds to time the smart glasses were on the wearer’s head. Note that plot 202 and plot 204 illustrate distinct differences in reflectance data when the smart glasses are being worn properly.

In the depicted example, reflectance behavior or values of light transmitted at a first wavelength (as depicted in plot 202) differs from the reflectance behavior or values of light transmitted at a second wavelength (as depicted in plot 204) for both periods when the wearable device is worn on a user’s face and for periods when the wearable device is not worn on the user’s face. As depicted in plot 206, a ratio between the reflectance data of the first and second light transmitters can provide reliable characteristic data that can be used to identify when a user is wearing or not wearing the wearable device. In some embodiments, the characteristic data of when a user is wearing or not wearing the wearable device can be utilized to identify, determine, or otherwise establish a threshold ratio or cutoff to determine when the user is wearing or not wearing the wearable device. Further, further analysis or comparison between the reflectance data of the first and second light transmitters can be utilized to provide characteristic data that can be used to identify when a user is wearing or not wearing the wearable device. In some embodiments, a spectrum analysis or similar techniques can be utilized to determine when a user is wearing or not wearing the wearable device, and/or establish threshold values for when a user is wearing or not wearing the wearable device. Similar wear detection sensor data may be used to detect when the device is, e.g., in a case, in a backpack, etc.

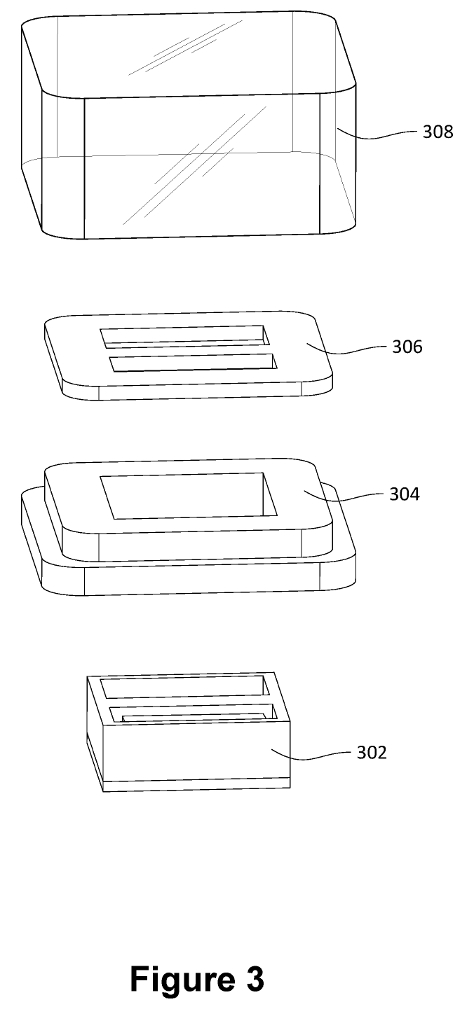

FIG. 3 illustrates an example wear detection sensor assembly in accordance with some embodiments. In the depicted example, the wear detection sensor can include components to protect the circuitry 302 of the wear detection sensor and improve the functionality of the wear detection sensor. Circuitry 302 may include one or more light- emitters, such as light emitting diodes (LEDs) and LED drivers, amplifiers, and one or more light detectors, such as one or more photodiodes, etc. In some embodiments, circuitry 302 may additionally include accelerometers to capture motion concurrently with capturing reflectance data. Plastic housing 304 may be configured to surround circuitry 302. A light-blocking layer 306 may be used to reduce cross-talk between light emitters, such as LEDs and light detectors, such as photodiodes to reduce capture of non-reflected light from the light emitters. An infrared transparent window 308 may be disposed over the light-blocking layer 306 and may attach to plastic housing 304 to, e.g., protect circuitry 302 while allowing transmitted and reflected light to pass through infrared transparent window 308.

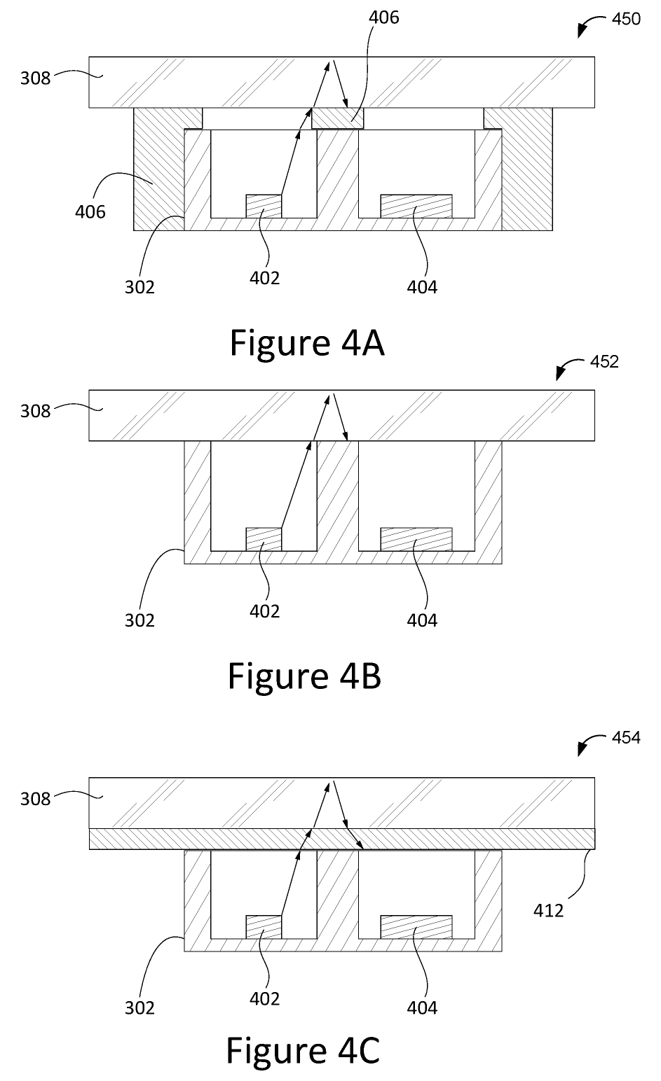

In some implementations, -wear detection sensor assembly can include features to reduce the amount of light reflected off the cover window (e.g., infrared transparent window 308) and further reduce crosstalk, improving a signal to cross-talk ratio for the wear detection sensor. FIGS. 4A-4C illustrate example implementations of a wear detection sensor assembly, in accordance with some embodiments. With reference to FIGS. 3 and 4A-4C , the wear detection sensor includes circuitry 302 and infrared transparent window 308. Circuitry 302 includes at least one LED 402 and a photodiode 404. During operation, some light emitted by the LED 402 may be reflected off a surface or interface of the infrared transparent window 308.

FIG. 4A illustrates a first wear detection sensor assembly 450 that utilizes a light-sealing gasket 406. As illustrated in FIG. 4A, a gasket 406 disposed between the infrared transparent window 308 and the sensor housing 304 can absorb light reflected by the infrared transparent window 308, preventing the internally reflected light from being captured by photodiode 404, thereby reducing or eliminating cross-talk between LED 402 and photodiode 404.

FIG. 4B illustrates a second wear detection sensor assembly- 406. As illustrated in FIG. 4B, a portion of the sensor housing 304a can extend between the LED 402 and photodiode 404 to block light reflected by the infrared transparent window 308, preventing the internally reflected light from being captured by photodiode 404, thereby reducing or eliminating cross-talk between LED 402 and photodiode 404. In some embodiments, as shown in FIG. 4B, the light sealing gasket can be excluded to reduce the overall thickness of the second sensor assembly stack up 452.

FIG. 4C illustrates a third wear detection sensor assembly 454 that includes a view control film 412. As illustrated in FIG. 4C, a view control film 412 disposed between the infrared transparent window 308 and the sensor housing 304 can guide or redirect light reflected by the infrared transparent window 308 away from the photodiode 404, preventing the internally reflected light from being captured by photodiode 404, thereby reducing or eliminating cross-talk between LED 402 and photodiode 404. In the depicted example, the view control film 412 can direct light passing therethrough to control the view angle and receive angle of the reflected light which reduces the cross-talk received by the photodiode 404.

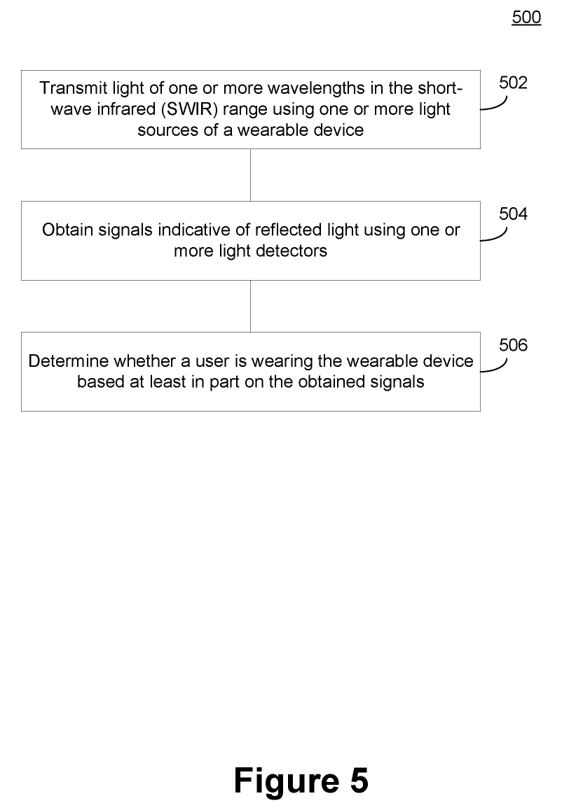

FIG. 5 is a flowchart of an example process 500 for detecting whether a user 115 is wearing a wearable device in accordance with some embodiments. In some implementations, blocks of process 500 may be executed by one or more processors of a wearable device (e.g., one or more processors of a pair of smart glasses, an AR/VR headset, etc.). An example of a computing device associated with such a wearable device is shown in and described below in connection with FIGS. 6A-6C-2. In some embodiments, blocks of process 500 may be executed in an order other than what is shown in FIG. 5. In some implementations, two or more blocks of process 500 may be executed substantially in parallel. In some implementations, one or more blocks of process 500 may be omitted.

Process 500 can begin at 502 by transmitting light of one or more wavelengths in the short-wave infrared (SWIR) range using one or more light sources of a wearable device. The wearable device may be a head-worn wearable device, such as a pair of smart glasses, an AR/VR headset, etc. The one or more light sources may be part of a “wear detection sensor,” e.g., as shown in and described above in connection with FIGS. 1-4. The wear detection sensor may include one or more light detectors (e.g., photodiodes 404), as shown in and described above in connection with FIGS. 1-4. The light emitted may be at one wavelength, or at two or more wavelengths. The wavelengths may be selected based on characteristics of skin absorption/reflection at the wavelengths. Note that light emitters and light detectors of the wear detection sensor may be separated by any suitable distance, e.g., 1 mm, 2 mm, 3 mm, 4 mm, etc. In some implementations, the distance may be between 2 and 3 mm.

At 504, process 500 can obtain signals indicative of reflected light (e.g., reflected off an object, reflected off the wearer’s skin, reflected off the wearer’s hair, etc.) using the one or more light detectors of the wear detection sensor.

At 506, process 500 can determine whether a user is wearing the wearable device based at least in part on the obtained signals. For example, in some embodiments, process 500 can compare a magnitude of a reflectance signal to a predetermined threshold to determine that the user is wearing the wearable device. As another example, in some embodiments, process 500 can take a ratio of two reflectance signals (e.g., each associated with a transmitted signal at a different wavelength) and can compare the ratio to a predetermined threshold. Process 500 can determine that the wearer is wearing the device responsive to determining that the ratio exceeds the predetermined threshold. In some embodiments, process 500 may utilize a model (e.g., a trained machine learning model) to determine whether the wearer is wearing the wearable device. For, example, in some implementations, process 500 may provide the obtained signals or a representation of the obtained signals (e.g., extracted features) to a machine learning model trained to classify the obtained signals as associated with wearing the device or not wearing the device.

In some embodiments, responsive to determining that the user is wearing the wearable device, process 500 can cause the wearable device to perform any suitable actions, such as resuming playback of particular media content (e.g., audio content, video content, AR/VR content, etc.), presenting notifications that were received, receiving and acting on user input such as gestures, button presses or the like, etc.

### EXAMPLE EMBODIMENTS

(A1) A head-wearable device 100, comprising: a frame configured to be worn on the face of a wearer, a wear detection sensor disposed in a portion of the frame, the wear detection sensor comprising at least one light emitter configured to emit light in a short-wave infrared (SWIR) wavelength range and at least one light detector configured to capture reflected light, and one or more processors configured to: cause the at least one light emitter to emit the light in the SWIR wavelength range, obtain signals characteristic of reflected light captured by the at least one light detector, and determine whether a user 115 is wearing the head-wearable device 100 on the face of the wearer based at least in part on the obtained signals.

In some embodiments, determining whether the user 115 is wearing a head-wearable device 100 includes first determining the proximity of the head-wearable device 100 to the user 115’s face (e.g., the user 115’s nose), and based on the reflectance determining if the object detected is the user 115’s skin or another object. Based on the reflectivity of the object, it can be determined whether it’s a person’s skin or another object (e.g., not the skin of the user 115). For example, the wear detection sensor includes a first light emitter (e.g., an LED 402) that can emit light at a first frequency and can indicate the proximity of the object (e.g., the user 115’s face or another object) from the head-wearable device 100. The example further includes a second light emitter (e.g., a second LED 402) that can emit another wavelength at a second frequency that can indicate what object the wavelength is reflected from such as the user 115’s nose or a sweater in a backpack. In some embodiments, the first and second wavelengths are emitted from the same LED 402 at different timed intervals (e.g., every 2 nanoseconds, every second, etc.). In some embodiments, the LED 402 is a 1000 nm LED 402. In some embodiments, the light emitter is a laser or another device that emits light. In some embodiments, the SWIR range includes a 900-2500 nm range.

In some embodiments, the first wavelength determines the proximity (e.g., distance) within a 1mm-15mm range. The distance from the head-wearable device 100 to the object can vary based on the object (e.g., objects within a backpack) or how far away the user 115’s nose is from the head-wearable device 100. The distance from the user 115’s face to the head-wearable device 100 depends on the wearer’s face shape and will differ from wearer to wearer. Thus, including the second wavelength emission can support whether or not the object is the user 115’s face or not. For example, if the reflection of the first wavelength indicates that an object is 3mm away, the reflection of the second wavelength determines if it’s the user 115’s face or if it’s another object. In some embodiments, only one wavelength is used to determine the distance between the user 115’s face and the head-wearable device 100.

(A2) In some embodiments of A1, the wear detection sensor is disposed on a portion of the frame configured to be proximate to the nose of the wearer.

(A3) In some embodiments of A1-A2, the wear detection sensor is disposed on a portion of the frame configured to be proximate to a nostril of the wearer.

(A4) In some embodiments of any of A1-A3, the wear detection sensor is disposed on a portion of the frame configured to be proximate to the bridge of the nose of the wearer.

(A5) In some embodiments of any of A1-A4, the wear detection sensor comprises a light-sealing gasket 406 disposed between circuitry 302 comprising the at least one light emitter and the at least one light detector and an infrared transparent window 308.

(A6) In some embodiments of any of A1-A5, the wear detection sensor is disposed in the frame such that the wear detection sensor is less than 30 mm from the face of the wearer when the head-wearable device 100 is worn.

(A7) In some embodiments of any of A1-A6, the at least one light emitter comprises two light emitters configured to emit light in two different wavelengths within the SWIR wavelength range.

(A8) In some embodiments of any of A1-A7, determining whether the user 115 is wearing the head-wearable device 100 comprises determining whether a ratio of reflected light associated with a first wavelength of the two different wavelengths to reflected light associated with a second wavelength of the two different wavelengths exceeds a predetermined threshold.

(B1) In accordance with some embodiments, a method includes causing at least one light emitter coupled to a head-wearable device 100 to emit light in an SWIR wavelength range, obtaining signals characteristic of reflected light captured by at least one light detector coupled to the head-wearable device 100, and determining whether a user 115 is wearing the head-wearable device 100 on the face of a wearer based at least in part on the obtained signals.

(B2) In some embodiments of B1, the at least one light emitter and the at least one light detector are disposed within a wear detection sensor coupled to the head-wearable device 100.

(B3) In some embodiments of B1-B2, the wear detection sensor is disposed on a portion of a frame of the head-wearable device 100 configured to be proximate to the nose of the wearer.

(B4) In some embodiments of any of B1-B3, the wear detection sensor comprises a light-sealing gasket 406 disposed between circuitry 302 comprising the at least one light emitter and the at least one light detector and an infrared transparent window 308.

(B5) In some embodiments of any of B1-B4, the at least one light emitter comprises two light emitters configured to emit light in two different wavelengths within the SWIR wavelength range.

(B6) In some embodiments of any of B1-B5, determining whether the user 115 is wearing the head-wearable device 100 comprises determining whether a ratio of reflected light associated with a first wavelength of the two different wavelengths to reflected light associated with a second wavelength of the two different wavelengths exceeds a predetermined threshold.

(C1) In accordance with some embodiments, a non-transitory computer-readable storage medium including instructions that, when executed by a computing device, cause the computing device to: cause at least one light emitter coupled to a head-wearable device 100 to emit light in an SWIR wavelength range, obtain signals characteristic of reflected light captured by at least one light detector coupled to the head-wearable device 100, and determine whether a user 115 is wearing the head-wearable device 100 on the face of a wearer based at least in part on the obtained signals.

(C2) In some embodiments of C1, the at least one light emitter and the at least one light detector are disposed within a wear detection sensor coupled to the head-wearable device 100.

(C3) In some embodiments of C1-C2, the wear detection sensor is disposed on a portion of a frame of the head-wearable device 100 configured to be proximate to the nose of the wearer.

(C4) In some embodiments of any of C1-C3, the wear detection sensor comprises a light-sealing gasket 406 disposed between circuitry 302 comprising the at least one light emitter and the at least one light detector and an infrared transparent window 308.

(C5) In some embodiments of any of C1-C4, the at least one light emitter comprises two light emitters configured to emit light in two different wavelengths within the SWIR wavelength range.

(C6) In some embodiments of any of C1-C5, determining whether the user 115 is wearing the head-wearable device 100 comprises determining whether a ratio of reflected light associated with a first wavelength of the two different wavelengths to reflected light associated with a second wavelength of the two different wavelengths exceeds a predetermined threshold.

The devices described above are further detailed below, including wrist-wearable devices 120, headset devices, systems, and haptic feedback devices. Specific operations described above may occur as a result of specific hardware. Such hardware is described in further detail below. The devices described below are not limiting. Features on these devices can be removed, or additional features can be added to these devices.

### Example Extended-Reality Systems

FIGS. 6A, 6B, 6C-1and6C-2, illustrate example XR systems that include AR and MR systems, in accordance with some embodiments. FIG. 6A shows a first XR system 600a and first example user interactions using a wrist-wearable device 626, a head-wearable device (e.g., AR device 628), and/or a HIPD 642. FIG. 6B shows a second XR system 600b and second example user interactions using a wrist-wearable device 626, AR device 628, and/or an HIPD 642. FIGS. 6C-1 and 6C-2 show a third MR system 600c and third example user interactions using a wrist-wearable device 626, a head-wearable device (e.g., an MR device such as a VR device), and/or an HIPD 642. As the skilled artisan will appreciate upon reading the descriptions provided herein, the above-example AR and MR systems (described in detail below) can perform various functions and/or operations.

The wrist-wearable device 626, the head-wearable devices, and/or the HIPD 642 can communicatively couple via a network 625 (e.g., cellular, near field, Wi-Fi, personal area network, wireless LAN). Additionally, the wrist-wearable device 626, the head-wearable device, and/or the HIPD 642 can also communicatively couple with one or more servers 630, computers 640 (e.g., laptops, computers), mobile devices 650 (e.g., smartphones, tablets), and/or other electronic devices via the network 625 (e.g., cellular, near field, Wi-Fi, personal area network, wireless LAN). Similarly, a smart textile-based garment, when used, can also communicatively couple with the wrist-wearable device 626, the head-wearable device(s), the HIPD 642, the one or more servers 630, the computers 640, the mobile devices 650, and/or other electronic devices via the network 625 to provide inputs.

Turning to FIG. 6A, a user 602 is shown wearing the wrist-wearable device 626 and the AR device 628 and having the HIPD 642 on their desk. The wrist-wearable device 626, the AR device 628, and the HIPD 642 facilitate user interaction with an AR environment. In particular, as shown by the first AR system 600a, the wrist-wearable device 626, the AR device 628, and/or the HIPD 642 cause presentation of one or more avatars 604, digital representations of contacts 606, and virtual objects 608. As discussed below, the user 602 can interact with the one or more avatars 604, digital representations of the contacts 606, and virtual objects 608 via the wrist-wearable device 626, the AR device 628, and/or the HIPD 642. In addition, the user 602 is also able to directly view physical objects in the environment, such as a physical table 629, through transparent lens(es) and waveguide(s) of the AR device 628. Alternatively, an MR device could be used in place of the AR device 628 and a similar user experience can take place, but the user would not be directly viewing physical objects in the environment, such as table 629, and would instead be presented with a virtual reconstruction of the table 629 produced from one or more sensors of the MR device (e.g., an outward facing camera capable of recording the surrounding environment).

The user 602 can use any of the wrist-wearable device 626, the AR device 628 (e.g., through physical inputs at the AR device and/or built-in motion tracking of a user’s extremities), a smart-textile garment, externally mounted extremity tracking device, the HIPD 642 to provide user inputs, etc. For example, the user 602 can perform one or more hand gestures that are detected by the wrist-wearable device 626 (e.g., using one or more EMG sensors and/or IMUs built into the wrist-wearable device) and/or AR device 628 (e.g., using one or more image sensors or cameras) to provide a user input. Alternatively, or additionally, the user 602 can provide a user input via one or more touch surfaces of the wrist-wearable device 626, the AR device 628, and/or the HIPD 642, and/or voice commands captured by a microphone of the wrist-wearable device 626, the AR device 628, and/or the HIPD 642. The wrist-wearable device 626, the AR device 628, and/or the HIPD 642 include an artificially intelligent digital assistant to help the user in providing a user input (e.g., completing a sequence of operations, suggesting different operations or commands, providing reminders, confirming a command). For example, the digital assistant can be invoked through an input occurring at the AR device 628 (e.g., via an input at a temple arm of the AR device 628). In some embodiments, the user 602 can provide a user input via one or more facial gestures and/or facial expressions. For example, cameras of the wrist-wearable device 626, the AR device 628, and/or the HIPD 642 can track the user 602’s eyes for navigating a user interface.

The wrist-wearable device 626, the AR device 628, and/or the HIPD 642 can operate alone or in conjunction to allow the user 602 to interact with the AR environment. In some embodiments, the HIPD 642 is configured to operate as a central hub or control center for the wrist-wearable device 626, the AR device 628, and/or another communicatively coupled device. For example, the user 602 can provide an input to interact with the AR environment at any of the wrist-wearable device 626, the AR device 628, and/or the HIPD 642, and the HIPD 642 can identify one or more back-end and front-end tasks to cause the performance of the requested interaction and distribute instructions to cause the performance of the one or more back-end and front-end tasks at the wrist-wearable device 626, the AR device 628, and/or the HIPD 642. In some embodiments, a back-end task is a background-processing task that is not perceptible by the user (e.g., rendering content, decompression, compression, application-specific operations), and a front-end task is a user-facing task that is perceptible to the user (e.g., presenting information to the user, providing feedback to the user). The HIPD 642 can perform the back-end tasks and provide the wrist-wearable device 626 and/or the AR device 628 operational data corresponding to the performed back-end tasks such that the wrist-wearable device 626 and/or the AR device 628 can perform the front-end tasks. In this way, the HIPD 642, which has more computational resources and greater thermal headroom than the wrist-wearable device 626 and/or the AR device 628, performs computationally intensive tasks and reduces the computer resource utilization and/or power usage of the wrist-wearable device 626 and/or the AR device 628.

In the example shown by the first AR system 600a, the HIPD 642 identifies one or more back-end tasks and front-end tasks associated with a user request to initiate an AR video call with one or more other users (represented by the avatar 604 and the digital representation of the contact 606) and distributes instructions to cause the performance of the one or more back-end tasks and front-end tasks. In particular, the HIPD 642 performs back-end tasks for processing and/or rendering image data (and other data) associated with the AR video call and provides operational data associated with the performed back-end tasks to the AR device 628 such that the AR device 628 performs front-end tasks for presenting the AR video call (e.g., presenting the avatar 604 and the digital representation of the contact 606).

In some embodiments, the HIPD 642 can operate as a focal or anchor point for causing the presentation of information. This allows the user 602 to be generally aware of where information is presented. For example, as shown in the first AR system 600a, the avatar 604 and the digital representation of the contact 606 are presented above the HIPD 642. In particular, the HIPD 642 and the AR device 628 operate in conjunction to determine a location for presenting the avatar 604 and the digital representation of the contact 606. In some embodiments, information can be presented within a predetermined distance from the HIPD 642 (e.g., within five meters). For example, as shown in the first AR system 600a, virtual object 608 is presented on the desk some distance from the HIPD 642. Similar to the above example, the HIPD 642 and the AR device 628 can operate in conjunction to determine a location for presenting the virtual object 608. Alternatively, in some embodiments, presentation of information is not bound by the HIPD 642. More specifically, the avatar 604, the digital representation of the contact 606, and the virtual object 608 do not have to be presented within a predetermined distance of the HIPD 642. While an AR device 628 is described working with an HIPD, an MR headset can be interacted with in the same way as the AR device 628.

User inputs provided at the wrist-wearable device 626, the AR device 628, and/or the HIPD 642 are coordinated such that the user can use any device to initiate, continue, and/or complete an operation. For example, the user 602 can provide a user input to the AR device 628 to cause the AR device 628 to present the virtual object 608 and, while the virtual object 608 is presented by the AR device 628, the user 602 can provide one or more hand gestures via the wrist-wearable device 626 to interact and/or manipulate the virtual object 608. While an AR device 628 is described working with a wrist-wearable device 626, an MR headset can be interacted with in the same way as the AR device 628.

### Integration of Artificial Intelligence with XR Systems

FIG. 6A illustrates an interaction in which an artificially intelligent virtual assistant can assist in requests made by a user 602. The AI virtual assistant can be used to complete open-ended requests made through natural language inputs by a user 602. For example, in FIG. 6A the user 602 makes an audible request 644 to summarize the conversation and then share the summarized conversation with others in the meeting. In addition, the AI virtual assistant is configured to use sensors of the XR system (e.g., cameras of an XR headset, microphones, and various other sensors of any of the devices in the system) to provide contextual prompts to the user for initiating tasks.

FIG. 6A also illustrates an example neural network 652 used in Artificial Intelligence applications. Uses of Artificial Intelligence (AI) are varied and encompass many different aspects of the devices and systems described herein. AI capabilities cover a diverse range of applications and deepen interactions between the user 602 and user devices (e.g., the AR device 628, an MR device 632, the HIPD 642, the wrist-wearable device 626). The AI discussed herein can be derived using many different training techniques. While the primary AI model example discussed herein is a neural network, other AI models can be used. Non-limiting examples of AI models include artificial neural networks (ANNs), deep neural networks (DNNs), convolution neural networks (CNNs), recurrent neural networks (RNNs), large language models (LLMs), long short-term memory networks, transformer models, decision trees, random forests, support vector machines, k-nearest neighbors, genetic algorithms, Markov models, Bayesian networks, fuzzy logic systems, and deep reinforcement learnings, etc. The AI models can be implemented at one or more of the user devices, and/or any other devices described herein. For devices and systems herein, that employ multiple AI models, different models can be used depending on the task. For example, for a natural-language artificially intelligent virtual assistant, an LLM can be used and for the object detection of a physical environment, a DNN can be used instead.

In another example, an AI virtual assistant can include many different AI models and based on the user’s request, multiple AI models may be employed (concurrently, sequentially or a combination thereof). For example, an LLM-based AI model can provide instructions for helping a user follow a recipe and the instructions can be based in part on another AI model that is derived from an ANN, a DNN, an RNN, etc. that is capable of discerning what part of the recipe the user is on (e.g., object and scene detection).

As AI training models evolve, the operations and experiences described herein could potentially be performed with different models other than those listed above, and a person skilled in the art would understand that the list above is non-limiting.

A user 602 can interact with an AI model through natural language inputs captured by a voice sensor, text inputs, or any other input modality that accepts natural language and/or a corresponding voice sensor module. In another instance, input is provided by tracking the eye gaze of a user 602 via a gaze tracker module. Additionally, the AI model can also receive inputs beyond those supplied by a user 602. For example, the AI can generate its response further based on environmental inputs (e.g., temperature data, image data, video data, ambient light data, audio data, GPS location data, inertial measurement (i.e., user motion) data, pattern recognition data, magnetometer data, depth data, pressure data, force data, neuromuscular data, heart rate data, temperature data, sleep data) captured in response to a user request by various types of sensors and/or their corresponding sensor modules. The sensors’ data can be retrieved entirely from a single device (e.g., AR device 628) or from multiple devices that are in communication with each other (e.g., a system that includes at least two of an AR device 628, an MR device 632, the HIPD 642, the wrist-wearable device 626, etc.). The AI model can also access additional information (e.g., one or more servers 630, the computers 640, the mobile devices 650, and/or other electronic devices) via a network 625.

A non-limiting list of AI-enhanced functions includes but is not limited to image recognition, speech recognition (e.g., automatic speech recognition), text recognition (e.g., scene text recognition), pattern recognition, natural language processing and understanding, classification, regression, clustering, anomaly detection, sequence generation, content generation, and optimization. In some embodiments, AI-enhanced functions are fully or partially executed on cloud-computing platforms communicatively coupled to the user devices (e.g., the AR device 628, an MR device 632, the HIPD 642, the wrist-wearable device 626) via the one or more networks. The cloud-computing platforms provide scalable computing resources, distributed computing, managed AI services, interference acceleration, pre-trained models, APIs and/or other resources to support comprehensive computations required by the AI-enhanced function.

Example outputs stemming from the use of an AI model can include natural language responses, mathematical calculations, charts displaying information, audio, images, videos, texts, summaries of meetings, predictive operations based on environmental factors, classifications, pattern recognitions, recommendations, assessments, or other operations. In some embodiments, the generated outputs are stored on local memories of the user devices (e.g., the AR device 628, an MR device 632, the HIPD 642, the wrist-wearable device 626), storage options of the external devices (servers, computers, mobile devices, etc.), and/or storage options of the cloud-computing platforms.

The AI-based outputs can be presented across different modalities (e.g., audio-based, visual-based, haptic-based, and any combination thereof) and across different devices of the XR system described herein. Some visual-based outputs can include the displaying of information on XR augments of an XR headset, user interfaces displayed at a wrist-wearable device, laptop device, mobile device, etc. On devices with or without displays (e.g., HIPD 642), haptic feedback can provide information to the user 602. An AI model can also use the inputs described above to determine the appropriate modality and device(s) to present content to the user (e.g., a user walking on a busy road can be presented with an audio output instead of a visual output to avoid distracting the user 602).

### Example Augmented Reality Interaction

FIG. 6B shows the user 602 wearing the wrist-wearable device 626 and the AR device 628 and holding the HIPD 642. In the second AR system 600b, the wrist-wearable device 626, the AR device 628, and/or the HIPD 642 are used to receive and/or provide one or more messages to a contact of the user 602. In particular, the wrist-wearable device 626, the AR device 628, and/or the HIPD 642 detect and coordinate one or more user inputs to initiate a messaging application and prepare a response to a received message via the messaging application.

In some embodiments, the user 602 initiates, via a user input, an application on the wrist-wearable device 626, the AR device 628, and/or the HIPD 642 that causes the application to initiate on at least one device. For example, in the second AR system 600b the user 602 performs a hand gesture associated with a command for initiating a messaging application (represented by messaging user interface 612); the wrist-wearable device 626 detects the hand gesture; and, based on a determination that the user 602 is wearing the AR device 628, causes the AR device 628 to present a messaging user interface 612 of the messaging application. The AR device 628 can present the messaging user interface 612 to the user 602 via its display (e.g., as shown by user 602’s field of view 610). In some embodiments, the application is initiated and can be run on the device (e.g., the wrist-wearable device 626, the AR device 628, and/or the HIPD 642) that detects the user input to initiate the application, and the device provides another device operational data to cause the presentation of the messaging application. For example, the wrist-wearable device 626 can detect the user input to initiate a messaging application, initiate and run the messaging application, and provide operational data to the AR device 628 and/or the HIPD 642 to cause presentation of the messaging application. Alternatively, the application can be initiated and run at a device other than the device that detected the user input. For example, the wrist-wearable device 626 can detect the hand gesture associated with initiating the messaging application and cause the HIPD 642 to run the messaging application and coordinate the presentation of the messaging application.

Further, the user 602 can provide a user input provided at the wrist-wearable device 626, the AR device 628, and/or the HIPD 642 to continue and/or complete an operation initiated at another device. For example, after initiating the messaging application via the wrist-wearable device 626 and while the AR device 628 presents the messaging user interface 612, the user 602 can provide an input at the HIPD 642 to prepare a response (e.g., shown by the swipe gesture performed on the HIPD 642). The user 602’s gestures performed on the HIPD 642 can be provided and/or displayed on another device. For example, the user 602’s swipe gestures performed on the HIPD 642 are displayed on a virtual keyboard of the messaging user interface 612 displayed by the AR device 628.

In some embodiments, the wrist-wearable device 626, the AR device 628, the HIPD 642, and/or other communicatively coupled devices can present one or more notifications to the user 602. The notification can be an indication of a new message, an incoming call, an application update, a status update, etc. The user 602 can select the notification via the wrist-wearable device 626, the AR device 628, or the HIPD 642 and cause presentation of an application or operation associated with the notification on at least one device. For example, the user 602 can receive a notification that a message was received at the wrist-wearable device 626, the AR device 628, the HIPD 642, and/or other communicatively coupled device and provide a user input at the wrist-wearable device 626, the AR device 628, and/or the HIPD 642 to review the notification, and the device detecting the user input can cause an application associated with the notification to be initiated and/or presented at the wrist-wearable device 626, the AR device 628, and/or the HIPD 642.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 628 can present to the user 602 game application data and the HIPD 642 can use a controller to provide inputs to the game. Similarly, the user 602 can use the wrist-wearable device 626 to initiate a camera of the AR device 628, and the user can use the wrist-wearable device 626, the AR device 628, and/or the HIPD 642 to manipulate the image capture (e.g., zoom in or out, apply filters) and capture image data.

While an AR device 628 is shown being capable of certain functions, it is understood that an AR device can be an AR device with varying functionalities based on costs and market demands. For example, an AR device may include a single output modality such as an audio output modality. In another example, the AR device may include a low-fidelity display as one of the output modalities, where simple information (e.g., text and/or low-fidelity images/video) is capable of being presented to the user. In yet another example, the AR device can be configured with face-facing light emitting diodes (LEDs) configured to provide a user with information, e.g., an LED around the right-side lens can illuminate to notify the wearer to turn right while directions are being provided or an LED on the left-side can illuminate to notify the wearer to turn left while directions are being provided. In another embodiment, the AR device can include an outward-facing projector such that information (e.g., text information, media) may be displayed on the palm of a user’s hand or other suitable surface (e.g., a table, whiteboard). In yet another embodiment, information may also be provided by locally dimming portions of a lens to emphasize portions of the environment in which the user’s attention should be directed. Some AR devices can present AR augments either monocularly or binocularly (e.g., an AR augment can be presented at only a single display associated with a single lens as opposed presenting an AR augmented at both lenses to produce a binocular image). In some instances, an AR device capable of presenting AR augments binocularly can optionally display AR augments monocularly as well (e.g., for power-saving purposes or other presentation considerations). These examples are non-exhaustive and features of one AR device described above can be combined with features of another AR device described above. While features and experiences of an AR device have been described generally in the preceding sections, it is understood that the described functionalities and experiences can be applied in a similar manner to an MR headset, which is described below in the proceeding sections.

### Example Mixed Reality Interaction

Turning to FIGS. 6C-1 and 6C-2, the user 602 is shown wearing the wrist-wearable device 626 and an MR device 632 (e.g., a device capable of providing either an entirely VR experience or an MR experience that displays object(s) from a physical environment at a display of the device) and holding the HIPD 642. In the third AR system 600c, the wrist-wearable device 626, the MR device 632, and/or the HIPD 642 are used to interact within an MR environment, such as a VR game or other MR/VR application. While the MR device 632 presents a representation of a VR game (e.g., first MR game environment 620) to the user 602, the wrist-wearable device 626, the MR device 632, and/or the HIPD 642 detect and coordinate one or more user inputs to allow the user 602 to interact with the VR game.

In some embodiments, the user 602 can provide a user input via the wrist-wearable device 626, the MR device 632, and/or the HIPD 642 that causes an action in a corresponding MR environment. For example, the user 602 in the third MR system 600c (shown in FIG. 6C-1) raises the HIPD 642 to prepare for a swing in the first MR game environment 620. The MR device 632, responsive to the user 602 raising the HIPD 642, causes the MR representation of the user 622 to perform a similar action (e.g., raise a virtual object, such as a virtual sword 624). In some embodiments, each device uses respective sensor data and/or image data to detect the user input and provide an accurate representation of the user 602’s motion. For example, image sensors (e.g., SLAM cameras or other cameras) of the HIPD 642 can be used to detect a position of the HIPD 642 relative to the user 602’s body such that the virtual object can be positioned appropriately within the first MR game environment 620; sensor data from the wrist-wearable device 626 can be used to detect a velocity at which the user 602 raises the HIPD 642 such that the MR representation of the user 622 and the virtual sword 624 are synchronized with the user 602’s movements; and image sensors of the MR device 632 can be used to represent the user 602’s body, boundary conditions, or real-world objects within the first MR game environment 620.

In FIG. 6C-2, the user 602 performs a downward swing while holding the HIPD 642. The user 602’s downward swing is detected by the wrist-wearable device 626, the MR device 632, and/or the HIPD 642 and a corresponding action is performed in the first MR game environment 620. In some embodiments, the data captured by each device is used to improve the user’s experience within the MR environment. For example, sensor data of the wrist-wearable device 626 can be used to determine a speed and/or force at which the downward swing is performed and image sensors of the HIPD 642 and/or the MR device 632 can be used to determine a location of the swing and how it should be represented in the first MR game environment 620, which, in turn, can be used as inputs for the MR environment (e.g., game mechanics, which can use detected speed, force, locations, and/or aspects of the user 602’s actions to classify a user’s inputs (e.g., user performs a light strike, hard strike, critical strike, glancing strike, miss) or calculate an output (e.g., amount of damage)).

FIG. 6C-2 further illustrates that a portion of the physical environment is reconstructed and displayed at a display of the MR device 632 while the MR game environment 620 is being displayed. In this instance, a reconstruction of the physical environment 646 is displayed in place of a portion of the MR game environment 620 when object(s) in the physical environment are potentially in the path of the user (e.g., a collision with the user and an object in the physical environment are likely). Thus, this example MR game environment 620 includes (i) an immersive VR portion 648 (e.g., an environment that does not have a corollary counterpart in a nearby physical environment) and (ii) a reconstruction of the physical environment 646 (e.g., table 650 and cup 652). While the example shown here is an MR environment that shows a reconstruction of the physical environment to avoid collisions, other uses of reconstructions of the physical environment can be used, such as defining features of the virtual environment based on the surrounding physical environment (e.g., a virtual column can be placed based on an object in the surrounding physical environment (e.g., a tree)).

While the wrist-wearable device 626, the MR device 632, and/or the HIPD 642 are described as detecting user inputs, in some embodiments, user inputs are detected at a single device (with the single device being responsible for distributing signals to the other devices for performing the user input). For example, the HIPD 642 can operate an application for generating the first MR game environment 620 and provide the MR device 632 with corresponding data for causing the presentation of the first MR game environment 620, as well as detect the user 602’s movements (while holding the HIPD 642) to cause the performance of corresponding actions within the first MR game environment 620. Additionally or alternatively, in some embodiments, operational data (e.g., sensor data, image data, application data, device data, and/or other data) of one or more devices is provided to a single device (e.g., the HIPD 642) to process the operational data and cause respective devices to perform an action associated with processed operational data.

In some embodiments, the user 602 can wear a wrist-wearable device 626, wear an MR device 632, wear smart textile-based garments 638 (e.g., wearable haptic gloves), and/or hold an HIPD 642 device. In this embodiment, the wrist-wearable device 626, the MR device 632, and/or the smart textile-based garments 638 are used to interact within an MR environment (e.g., any AR or MR system described above in reference to FIGS. 6A-6B). While the MR device 632 presents a representation of an MR game (e.g., second MR game environment 620) to the user 602, the wrist-wearable device 626, the MR device 632, and/or the smart textile-based garments 638 detect and coordinate one or more user inputs to allow the user 602 to interact with the MR environment.

In some embodiments, the user 602 can provide a user input via the wrist-wearable device 626, an HIPD 642, the MR device 632, and/or the smart textile-based garments 638 that causes an action in a corresponding MR environment. In some embodiments, each device uses respective sensor data and/or image data to detect the user input and provide an accurate representation of the user 602’s motion. While four different input devices are shown (e.g., a wrist-wearable device 626, an MR device 632, an HIPD 642, and a smart textile-based garment 638) each one of these input devices entirely on its own can provide inputs for fully interacting with the MR environment. For example, the wrist-wearable device can provide sufficient inputs on its own for interacting with the MR environment. In some embodiments, if multiple input devices are used (e.g., a wrist-wearable device and the smart textile-based garment 638) sensor fusion can be utilized to ensure inputs are correct. While multiple input devices are described, it is understood that other input devices can be used in conjunction or on their own instead, such as but not limited to external motion-tracking cameras, other wearable devices fitted to different parts of a user, apparatuses that allow for a user to experience walking in an MR environment while remaining substantially stationary in the physical environment, etc.

As described above, the data captured by each device is used to improve the user’s experience within the MR environment. Although not shown, the smart textile-based garments 638 can be used in conjunction with an MR device and/or an HIPD 642.

While some experiences are described as occurring on an AR device and other experiences are described as occurring on an MR device, one skilled in the art would appreciate that experiences can be ported over from an MR device to an AR device, and vice versa.

### Other Interactions

While numerous examples are described in this application related to extended-reality environments, one skilled in the art would appreciate that certain interactions may be possible with other devices. For example, a user may interact with a robot (e.g., a humanoid robot, a task specific robot, or other type of robot) to perform tasks inclusive of, leading to, and/or otherwise related to the tasks described herein. In some embodiments, these tasks can be user specific and learned by the robot based on training data supplied by the user and/or from the user's wearable devices (including head-worn and wrist-worn, among others) in accordance with techniques described herein. As one example, this training data can be received from the numerous devices described in this application (e.g., from sensor data and user-specific interactions with head-wearable devices, wrist-wearable devices, intermediary processing devices, or any combination thereof). Other data sources are also conceived outside of the devices described here. For example, AI models for use in a robot can be trained using a blend of user-specific data and non-user specific-aggregate data. The robots may also be able to perform tasks wholly unrelated to extended reality environments and can be used for performing quality-of-life tasks (e.g., performing chores, completing repetitive operations, etc.). In certain embodiments or circumstances, the techniques and/or devices described herein can be integrated with and/or otherwise performed by the robot.

Some definitions of devices and components that can be included in some or all of the example devices discussed are defined here for ease of reference. A skilled artisan will appreciate that certain types of the components described may be more suitable for a particular set of devices, and less suitable for a different set of devices. But subsequent reference to the components defined here should be considered to be encompassed by the definitions provided.

In some embodiments example devices and systems, including electronic devices and systems, will be discussed. Such example devices and systems are not intended to be limiting, and one of skill in the art will understand that alternative devices and systems to the example devices and systems described herein may be used to perform the operations and construct the systems and devices that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt in or opt out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A head-wearable device, comprising:
a frame configured to be worn on a face of a user;
a wear detection sensor disposed in a portion of the frame, the wear detection sensor comprising:
at least one light emitter configured to emit light in a short-wave infrared (SWIR) wavelength range; and
at least one light detector configured to capture reflected light emitted by the at least one light emitter; and
one or more processors configured to:
cause the at least one light emitter to emit the light in the SWIR wavelength range;
obtain signals characteristic of reflected light emitted by the at least one light emitter captured by the at least one light detector; and
determine whether a user is wearing the head-wearable device on the face of the user based at least in part on the obtained signals.

2. The head-wearable device of claim 1, wherein the wear detection sensor is disposed on a portion of the frame configured to be proximate to a nose of the user.

3. The head-wearable device of claim 2, wherein the wear detection sensor is disposed on a portion of the frame configured to be proximate to a nostril of the user.

4. The head-wearable device of claim 2, wherein the wear detection sensor is disposed on a portion of the frame configured to be proximate to a bridge of the nose of the user.

5. The head-wearable device of claim 1, wherein the wear detection sensor further comprises a light sealing gasket disposed between the at least one light emitter and the at least one light detector.

6. The head-wearable device of claim 1, wherein the wear detection sensor is configured to be spaced apart from the face of the user when the head-wearable device is worn.

7. The head-wearable device of claim 6, wherein the wear detection sensor is configured to be less than 30 millimeters away from the face of the user when the head-wearable device is worn.

8. The head-wearable device of claim 1, wherein the processor is further configured to determine a proximity of the face of the user to the head-wearable device based at least in part on the obtained signals.

9. The head-wearable device of claim 1, wherein the at least one light emitter comprises a plurality of light emitters, wherein each light emitter of the plurality of light emitters is configured to emit light at a distinct wavelength within the SWIR wavelength range.

10. The head-wearable device of claim 9, wherein the at least one light detector is configured to capture reflected light emitted by each of the plurality of light emitters.

11. The head-wearable device of claim 10, wherein the processor is further configured to:
determine a ratio of captured reflected light emitted by a first light emitter of the plurality of light emitters at a first wavelength and captured reflected light emitted by a second light emitter of the plurality of light emitters at a second wavelength; and
determine whether the user is wearing the head-wearable device on the face of the user based on if the ratio exceeds a predetermined threshold.

12. A method, comprising:
causing the at least one light emitter to emit the light in the SWIR wavelength range;
obtaining signals characteristic of reflected light emitted by the at least one light emitter captured by the at least one light detector; and
determining whether a user is wearing the head-wearable device on the face of the user based at least in part on the obtained signals.

13. The method of claim 12, further comprising determining a proximity of the face of the user to the head-wearable device based at least in part on the obtained signals.

14. The method of claim 12, wherein:
the at least one light emitter comprises a plurality of light emitters, and
each light emitter of the plurality of light emitters is configured to emit light at a distinct wavelength within the SWIR wavelength range.

15. The method of claim 14, wherein the at least one light detector is configured to capture reflected light emitted by each of the plurality of light emitters.

16. The method of claim 15, wherein the processor is further configured to:
determine a ratio of captured reflected light emitted by a first light emitter of the plurality of light emitters at a first wavelength and captured reflected light emitted by a second light emitter of the plurality of light emitters at a second wavelength; and
determine whether the user is wearing the head-wearable device on the face of the user based on if the ratio exceeds a predetermined threshold.

17. A non-transitory computer readable storage medium including instructions that, when executed by a computing device, cause the computing device to:
cause at least one light emitter coupled to a head-wearable device to emit light in an SWIR wavelength range;
obtain signals characteristic of reflected light captured by at least one light detector coupled to the head-wearable device; and
determine whether a user is wearing the head-wearable device on a face of a user based at least in part on the obtained signals.

18. The non-transitory computer readable storage medium of claim 17, wherein:
the at least one light emitter comprises a plurality of light emitters, and
each light emitter of the plurality of light emitters is configured to emit light at a distinct wavelength within the SWIR wavelength range.

19. The non-transitory computer readable storage medium of claim 18, wherein the at least one light detector is configured to capture reflected light emitted by each of the plurality of light emitters.

20. The non-transitory computer readable storage medium of claim 19, further including instructions that cause the computing device to:
determine a ratio of captured reflected light emitted by a first light emitter of the plurality of light emitters at a first wavelength and captured reflected light emitted by a second light emitter of the plurality of light emitters at a second wavelength; and
determine whether the user is wearing the head-wearable device on the face of the user based on if the ratio exceeds a predetermined threshold.
